(19) United States
(12) Patent Application Publication
(10) Pub. No.: US 2009/0114753 A1
(43) Pub. Date: May 7, 2009

(54) Circular Slot Magnetized Liner

(75) Inventors: Lu-Sheng Zhou, Beijing (CN); Lian-Shu Dong, Beijing (CN)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: JPHOKU CHEMICAL CO., LTD., TOKYO (JP)

(21) Appl. No.: 12/281,208

(22) PCT Filed: Nov. 21, 2006
(86) PCT No.: PCT/CN06/03128

§ 371 Date: Oct. 1, 2008

(30) Foreign Application Priority Data
Jun. 22, 2006 (CN) 200620120740.X

(51) Int. Cl. B02C 17/00

(52) U.S. Cl. 241/300

(57) ABSTRACT

The invention relates to a ring-slot type magnetic liner comprising guard plates, permanent magnetic bodies, binders and medium protecting layers, wherein, more than one dead slots are equidistantly arranged on the structure of said guard plates along the circumferential direction, a permanent magnetic body installed in each of said dead slots, and along the circumferential direction of the guard plate, one coil is set as N pole and the other coil is set as S pole. Each of the protecting layers is formed on the surface of the guard plate and is of annular shape in the circumferential direction. The invention allows the grinding operation to be carried out in the slots of the ring-slot shaped protecting layer which is formed from cracked grinding balls. The grinding balls contact the materials at an angle of about 120°, and the grinding efficiency is kept constant. Therefore the attritioning efficiency and yield may be increased.

### CROSS REFERENCES TO RELATED APPLICATIONS

This is a U.S. National Stage Application which claims the benefit of priority, under 35 U.S.C. §356(c) to International Patent Application No. PCT/CN2006/003128, filed on Nov. 21, 2006, which in turn claims priority to Chinese Patent Application No. 200620120740.X, filed on Jun. 22, 2006.

### BACKGROUND OF THE INVENTION

1. Field of the Invention

The present invention relates to ball mill and tube mill liners in the pulverizing engineering field, in particular, to a magnetic liner used for two stage type (fine grinding and rough grinding) ball mills.

2. Description of the Related Art

In the 1980s, SKEGA in Sweden invented a “rubber magnetic liner” applicable to fine grinding and regrinding ball mills with medium diameters ≦50 mm. This “rubber magnetic liner” improved various technical parameters of and the life span of previous ball mill and tube mill liners.

In the 1990s, a “metal-rubber magnetic liner” and a “heavy magnetic liner” were invented in China. The former may be used for fine grinding ball mills with medium diameters ≦60 mm, and the latter may be used for fine grinding and rough grinding ball mills with medium diameters ≦80 mm-100 mm. Now, these liners have been widely used domestically and abroad because they increase mill life span, decrease ball consumption, decrease power consumption and improve production. Although the grinding efficiency of large-scale ball mills is slightly improved, the efficiencies of middle and small sized ball mills are still generally very low. The main reason is that the total thickness of a magnetic liner with a protecting layer is usually larger than the thickness of a metal liner, which has great adverse effect on the effective volume of the mills. Therefore the efficiency of middle and small sized ball mills is relatively low, and the yield is limited. As a result, magnetic liners are not widely used in middle and small sized ball mills.

A Chinese Patent 03244303.X filed by the applicant of the present application discloses a magnetic liner having a protecting layer of a wave-sloped structure. In this magnetic liner, the grinding medium is in point and line contact with the protecting layer, and the grinding efficiency is low. The present invention is an important innovation based on the above application.

The above discussed conventional magnetic liners still have numerous structural defects and are not convenient to use. It is desirable to provide a new, small-sized and low cost magnetic liner whose functions may be adjusted to accommodate various conditions and applications.

### SUMMARY OF THE INVENTION

It is an object of the present invention to overcome the defects of the existing magnetic liners. The technical problems to be solved are: improving the impact of the attritioning medium grinding balls on the materials, improving the grinding conditions in the attritioning apparatus, and increasing the attritioning efficiency and the production per machine hour. Thus, the yield can be increased and the magnetic liners can be widely used in middle and small sized ball mills.

The present invention addresses the above objectives and technical problems. In an exemplary embodiment, the invention includes a slotted cylindrical magnetic liner, comprising one or more protective plates, one or more permanent magnets, a binding agent and a protective layer, wherein the one or more protective plates are arranged along the circumference and form a cylindrical body. The protective plates form an inner surface of the slotted cylindrical magnetic liner. One or more slots may be equidistantly arranged in the protective plates axially along the cylindrical body; a permanent magnet is installed in each of said slots. The protecting layer may have a wave-shaped and may be formed on the surface of the protective plates axially along the cylindrical body.

In an exemplary embodiment, the one or more protective plates are configured such that opposite N and S magnetic poles around the cylindrical body are interspersed axially along the cylindrical body.

In an exemplary embodiment, one or more slot housings with reinforcing sheets are arranged on the one or more protective plates. The slot housings may be formed by integral molding or by connecting separate housings together. Preferably the protecting layer has an annular shape and is attached to the surface of the one or more protective plates. Grooves along a direction of the axis of the cylindrical body may be formed by the magnetic field generated by the permanent magnets.

In an exemplary embodiment, the permanent magnets adhere to a surface of the slot housings, located on the protective plates, by applying at least one binding agent. A grinding medium provided in the slotted cylindrical magnetic liner may directly contact protecting layer.

In an exemplary embodiment, the spaces between the magnets correspond to the diameter of the grinding medium.

In an exemplary embodiment, the protective layer is formed of cracked grinding balls, steel segments or other ferromagnetic materials with good magnetoconductivity.

In an exemplary embodiment, the material of the protective plates may be paramagnetic steel, non-magnetic steel, rubber, nylon, polyurethane products, or a composite material containing magneto conductive elements.

The present invention has remarkable advantages and beneficial effects in comparison with the prior art. The ring-slot type magnetic liner according to the present invention has many technical advantages and may have a wide variety of applications. The advantages of the invention may at least include:
1. After the ring-slots are formed in the magnetic liner protective layers, materials can be retained in the slots; thus, the grinding area can be increased. A magnetic system can be customized according to the size of the attritioning medium such that the protective layers of the invention directly contact the attritioning medium grinding balls, thus improving the grinding efficiency.
2. The lifting-disengaging angle of the grinding body grinding balls may be larger in comparison to wavelike liner. That is, the grinding body disengages after being lifted at an earlier time. With the same rotating rate and filling ratio, work of raising the medium population during grinding is smaller, thus achieving energy conservation.
3. The grinding body seldom impacts and wears away the liner. As a result, the grinding body retains its abrasive properties longer as compared to conventional liners.
4. No riser plates exist in the slots, so the grinding body will not generate pulsating movements caused by uneven lifting. So vibration and noise can be lowered.
5. The liner is light-weight and is relatively thin, so it can be used with middle and small sized ball mills without adversely effecting yield.
6. The liner may also be used with large-scale ball mills, provided that the magnetic field strength is increased and the liner structure is reinforced.

The high-efficiency ring-slot type magnetic liner according to the present invention may replace the various existing magnetic liners or other liners used in fine grinding ball mills. The liner of the present invention may improve the grinding efficiency and the mill or liner life span.

Consequently, the ring-slot type magnetic liner according to the present invention can improve the grinding efficiency and increase production capacity. The invention has numerous advantages and uses; enhanced structure, operational capability and functions; remarkable technical advances, and improved accessibility and practicability. In comparison with the existing magnetic liners, the magnetic liner according to the present invention has: additional functions, a new, advanced and practical design and broad industrial utility.

Still other advantages will become readily apparent to those skilled in the art from the following detailed description, wherein the preferred embodiments are shown and described in conjunction with the drawings, simply by way of illustration of the best mode contemplated.

### BRIEF DESCRIPTION OF THE DRAWINGS

FIG. 1 shows a three-dimensional diagram of an exemplary embodiment of the ring-slot type magnetic liner.

FIG. 2 shows a sectional view of an exemplary embodiment of the ring-slot type magnetic liner.

FIG. 3 shows a sectional view of an exemplary embodiment of the ring-slot type magnetic liner.

### DETAILED DESCRIPTION OF THE PREFERRED EMBODIMENTS

Exemplary embodiments of the invention are provided in the following descriptions and drawings, which are not intended to limit the scope of the invention.

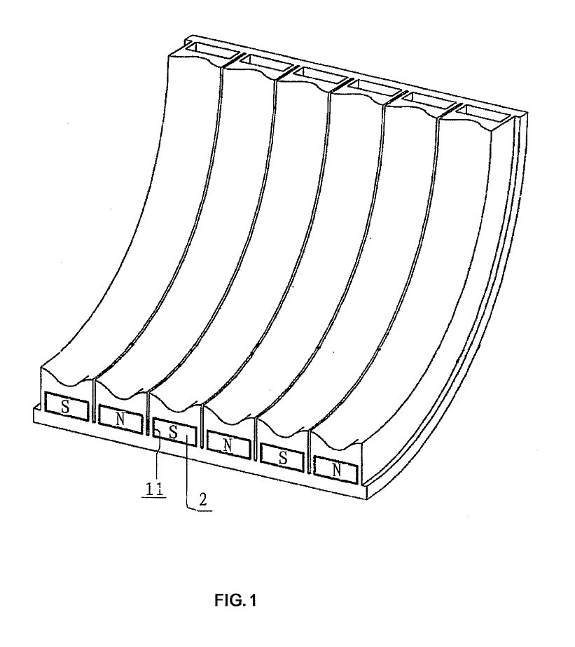

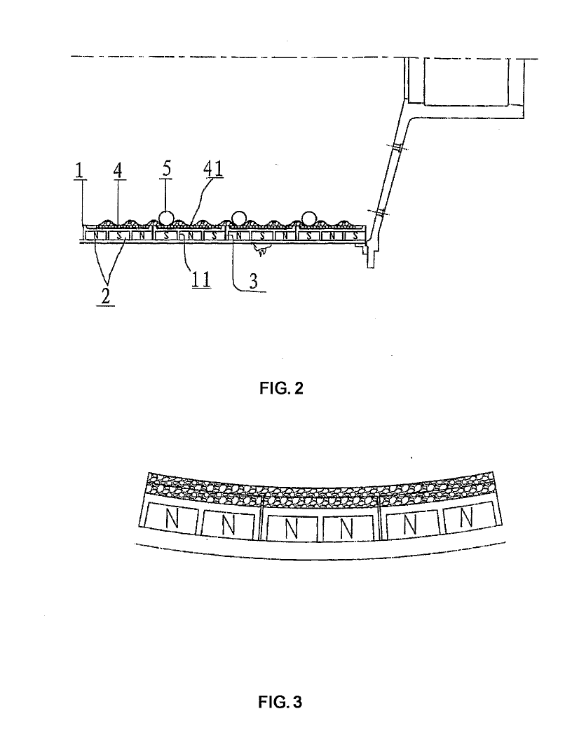

Referring to FIGS. 1, 2 and 3, a ring-slot type magnetic liner according to one preferred embodiment is shown. The liner comprises: protective plates 1, permanent magnets 2, binding agent 3 and protective layers 4.

A number of protective plates 1 may be arranged along the circumference and may form a cylindrical body. At least one protecting layer, 4 which may have a wave-shaped peak-valley structure, may be formed on the surface of protective plates 1 axially along the cylindrical body. One or more slots 11 may be arranged on protective plates 1 axially along the cylindrical body. Slots 11 may be uniformly or equidistantly spaced apart from one another. A magnet 2, preferably having enduring magnetic properties, may be installed in each of said slots 11. Permanent magnet 2 may adhered to protective plate 1 via binding agent 3. In operation, a grinding medium 5 may be provided in the slotted cylindrical magnetic liner and may directly contact protective layer 4. Protective layer 4 may be formed from small or cracked medium attached to the liner surface. In an exemplary embodiment, this medium may be small or fractured materials such as material fragments or particles. The small or cracked medium may be produced by long-term friction and impact of grinding medium 5, such as grinding balls or cast segments, against the materials. Because protecting layers 4 have a ring-slot type structure, material layers 41 can be retained in the slots of protective layers 4, and the grinding operation can be carried out in the slots.

The one or more protective plates 1 are configured such that N and S opposite magnetic poles around the cylindrical body are interspersed axially along the cylindrical body, as shown in FIG. 1. The protective layer 4 maybe formed from cracked grinding balls, steel segments or other ferromagnetic materials with good magnetoconductivity. Depending upon the arrangement of permanent magnets 2, the generated magnetic fields may have different electric field strengths at different locations. Therefore the wave structure of protecting layers 4 may be formed when more ferromagnetic material of protective layer 4 gather in areas having a strong magnetic field, thereby forming a bulge, than in weak magnetic field areas, thereby forming a groove. Moreover, because a circular N pole of the permanent magnet and a circular S pole of the permanent magnet 2 may be alternately arranged in the axial direction of the cylindrical body, the surface of the magnetic liner may form a ring-slot shape, i.e. a circular-groove liner. Grinding medium 5 may be arranged in line and surface contact with the protecting layer 4, so as to increase grinding efficiency. The spaces between the ring-slots may be adjusted. The corresponding spaces between the permanent magnets can be selected based on the diameter of grinding medium 5.

In an exemplary embodiment, the material of protective plates 1 may be paramagnetic steel, non-magnetic steel, rubber, nylon, polyurethane products, or a composite material containing magnetoconductive elements. The magnetic liner may be directly attached to the inner surface of the mills by the magnetic force of permanent magnets 2, without using bolts. Opposite N and S magnetic poles arranged around the cylindrical body may be interspersed along a direction of the axis of the cylindrical body so as to change the magnetic system of the existing magnetic liner. The surface of the magnetic liner may be formed by the protective layers having a ring-slot shape. The materials may be retained in the grooves of protective layers 4. Grinding medium 5 may contact the materials at an angle of about 120°, and impacting and grinding may be carried out in line and surface contact. The grinding efficacy of the grinding medium 5 on the materials may be kept constant, and the grinding efficiency may be increased considerably. Thus the objectives of high-efficiency milling and enhanced yield may be achieved.

Additional advantages and modifications of the invention will readily occur to those skilled in the art. Therefore, the invention is not limited to the specific details and representative embodiments shown and described herein. Accordingly, various modifications may be made without departing from the spirit or scope of the general inventive concept as defined by the appended claims and their equivalents.

1. A slotted cylindrical magnetic liner, comprising;
a protective plate comprising a cylindrical body, wherein said cylindrical body forms an inner surface of the liner;
at least two slots equidistantly arranged from each other on the protective plate, wherein said slots are located in an axial direction of the cylindrical body;
a magnet, located in at least one of said slots;
a binding agent; and
a protective layer located on a surface of the protective plate, wherein the protective layer has a wave shape comprising a peak and a groove.

2. The slotted cylindrical magnetic liner of claim 1, further comprising a plurality of magnets, wherein the protective plate is configured such that N and S magnetic poles of said magnets are arranged around and interspersed along an axial direction of the cylindrical body.

3. The slotted cylindrical magnetic liner of claim 1, wherein said slots comprise a housing, and wherein said housing is integrally molded to or separately connected to a surface of the protective plate.

4. The slotted cylindrical magnetic liner of claim 1, wherein said protective layer has an annular shape and is attached to a surface of the protective plate, wherein said grooves is located along an axial direction of the cylindrical body and formed by a magnetic field generated by said magnets.

5. The slotted cylindrical magnetic liner of claim 1, wherein a binding agent binds the magnet to a surface of said slots, and wherein said liner further comprises a grinding medium which directly contacts the protective layer.

6. The slotted cylindrical magnetic liner of claim 1, wherein a material is located in the grove of the protective layer.

7. The slotted cylindrical magnetic liner of claim 1, further comprising a grinding medium and a plurality of magnets, wherein said magnets are separated by a space corresponding to a diameter of a grinding medium.

8. The slotted cylindrical magnetic liner of claim 1, wherein said protective layer is formed from a material selected from the group consisting of: cracked grinding balls, steel segments and magnetoconductive ferromagnetic materials.

9. The slotted cylindrical magnetic liner of claim 1, wherein said protective plate is fabricated from a material selected from the group consisting of: paramagnetic steel, non-magnetic steel, rubber, nylon, polyurethane products, and a composite material containing magneto-conductive elements.

10. The slotted cylindrical magnetic liner of claim 2, wherein said slots comprise a housing, and wherein said housing is integrally molded to or separately connected to a surface of the protective plate.

11. The slotted cylindrical magnetic liner of claim 4, wherein a material is located in the grove of the protective layer.

12. The slotted cylindrical magnetic liner of claim 5, further comprising a plurality of magnets, wherein said magnets are separated by a space corresponding to a diameter of said grinding medium.

13. The slotted cylindrical magnetic liner of claim 4, wherein said protective layer is formed from a material selected from the group consisting of: cracked grinding balls, steel segments and magnetoconductive ferromagnetic materials.

14. The slotted cylindrical magnetic liner of claim 2, wherein said protective plate is fabricated from a material selected from the group consisting of: paramagnetic steel, non-magnetic steel, rubber, nylon, polyurethane products, and a composite material containing magnetoconductive elements.
